(19) United States
(12) Patent Application Publication
(10) Pub. No.: US 2005/0187820 A1
(43) Pub. Date: Aug. 25, 2005

(54) Participating in an incentive program using a portable memory device

(76) Inventor: Krishna Mohan, Naperville, IL (US)

Correspondence Address: Mr. Krishna Mohan, 3528 Breitwieser Lane, Naperville, IL, 60564, US

(21) Appl. No.: 10/784,765

(22) Filed: Feb. 23, 2004

(51) Int. Cl. G06F 17/60

(52) U.S. Cl. 705/14

(57) ABSTRACT

A method and system for using a portable memory device, for example, a removable USB flash memory drive, by a customer to participate in an incentive program. A business entity temporarily receives the memory device from the customer, for example, at a point of sale, and looks for an identification means of the customer in the device and creates one if it doesn't exists. The identification means comprises a unique customer identifier and an association means and various other data elements. The business entity uses the identifier in the device to establish link between the device and the incentive program. In one embodiment, the incentive program account is created by the entity without requesting any information from the customer, by creating a unique anonymous customer identifier in the device. The customer may use the device as one centralized unit to represent a plurality of incentive programs.

### CROSS-REFERENCE TO RELATED APPLICATIONS

Not Applicable.

### STATEMENT REGARDING FEDERALLY SPONSORED RESEARCH OR DEVELOPMENT

Not Applicable.

### SEQUENCE LISTING OR PROGRAM

Not Applicable.

### BACKGROUND OF THE INVENTION-FIELD OF THE INVENTION

The present invention, in its broader aspect, relates to a method and system for providing incentive programs for customers and particularly, to a method and system for using a portable memory device to participate in an incentive program and a customer using the portable memory device as one centralized unit to represent a plurality of incentive and membership programs.

### BACKGROUND OF THE INVENTION

Many businesses provide incentive programs to customers to attract and retain frequent customers. Some examples of this program are frequent flyer programs, grocery card programs and the like. Typically, these programs provide incentive to customers based on their buying pattern with the business. Many of these incentive programs require customer to provide personal information, for example, name, address, telephone number, email address and the like. Other incentive programs may not need user registration, for example, a fast food restaurant may provide a “stamp” every time a customer makes a purchase and after the customer collects certain number of stamps, the customer may redeem them for a free meal. Some other incentive programs are membership based and may be associated with yearly fee.

Current incentive programs require user to register with each business and need to carry various cards, collection of “stamps” and the like. So users can easily get discouraged and may not participate in such programs to full extent. So there is need in the art to provide one centralized unit for representing all incentive programs that can be used with a plurality of businesses. Further, there is requirement in the art to cut down the amount of time required to register users into such programs and moreover, there is a requirement in the art to anonymously identify customers without requesting personal information from them to enroll into such programs.

In general, what is needed is a method and system using which a business entity can instantly create an incentive program account for a customer, for example, at a point of sale, preferably, without requesting any information from customers by temporarily receiving a portable memory from the customer; and the business can use same portable memory during subsequent visits to identify the customer and provide participation in the incentive program and the customer may use the portable memory to consolidate several such incentive programs into one convenient portable unit.

Further objects and advantages of present invention will become apparent from a consideration of the ensuing detailed description and drawings.

### BACKGROUND OF THE INVENTION-PRIOR ART

Patent application Ser. No. 10/763,991 by Krishna Mohan, who is also the inventor of this invention, provides a method for point of sale (POS) data gathering using a portable memory device, which can be used to collect electronic receipts and transaction data files from a plurality of point of sale business transactions. This invention also provides a method for vendors to read a unique customer identification data from a configuration file from the device, which is created by customer using a set of unique customer identifier values. Even though this method has provided anonymously identifying a customer at the point of sale and then gathering transaction data of the customer with the unique customer identifier, it would be desirable to create the unique customer identifier by business, rather than by the customer, thereby eliminating this task on the part of customer and to promote creation of instant incentive program account at the point of sale. Moreover, the patent application Ser. No. 10/763,991 does not intend to solve aforementioned problems associated with incentive programs.

### BRIEF SUMMARY OF THE INVENTION

In accordance with the present invention, a method and system for using a portable memory to participate in at least one incentive program provided by an entity is disclosed. A customer temporarily provides the portable memory to the entity, for example, during a point of sale business transaction or at a customer service center. The entity checks whether identification means corresponding to the entity exists in the portable memory device. The identification means comprises of a unique customer identifier that uniquely identifies the customer to the entity. If the identification means does not exist, the entity creates it in the portable memory device and creates the persistent incentive program account using the unique customer identifier. During subsequent visits by the customer, the entity reads the portable memory and provides participation in the incentive program by using the unique customer identifier. In one embodiment, the unique customer identifier is an anonymous identification of the customer and is created by the entity without requesting any information from the customer and is created instantly at a point of sale. The identification means further comprises an association means to identify the association of the unique customer identifier with the entity. For example, this identification means may be a file created by the entity in the portable memory with unique file name, wherein one of the data contents of the file is the unique customer identifier. The association means is the file name, using which the entity can identify the unique customer identifier.

In another aspect of the present invention, the identification means created by the entity may contain various personal information of the customer and may comprise of digital photo and/or signature of the customer. The identification means, for example, a file or a directory created by the entity is digitally signed by the entity and accessible only by the entity. Such identification means may be used to provide participation in membership based incentive programs and to reduce fraudulent participation.

In one more aspect of the present invention, the entity allows to use the identification means file created by the entity at a point of sale, as a cookie file to anonymously identify with an associated web site or to use the cookie file as identification means in the portable memory device to participate in an incentive program at a point of sale with the entity.

### BRIEF DESCRIPTION OF THE DRAWINGS

For a more complete understanding of the present invention, and for further features and advantages thereof, reference is now made to the following description taken in conjunction with the accompanying drawings, wherein, like reference numbers represent corresponding parts throughout, in which:

FIG. 1 is a diagram that shows few types of exemplary portable memory devices that may be used to practice the present invention;

FIG. 2 is a data flow diagram illustrating the method of using a portable memory device to participate in an incentive program provided by an entity;

FIG. 3A is a block diagram illustrating exemplary file system contents of a portable memory device of a customer showing identification means from a plurality of entities;

FIG. 3B is a block diagram illustrating an exemplary identification means file contents;

FIG. 3C is a block diagram illustrating an exemplary identification means file contents, which is also a cookie file placed by an associated web site; and

FIG. 4 illustrate a block diagram of an exemplary system used by an incentive program provider entity to practice the teachings of the present invention.

### DETAILED DESCRIPTION

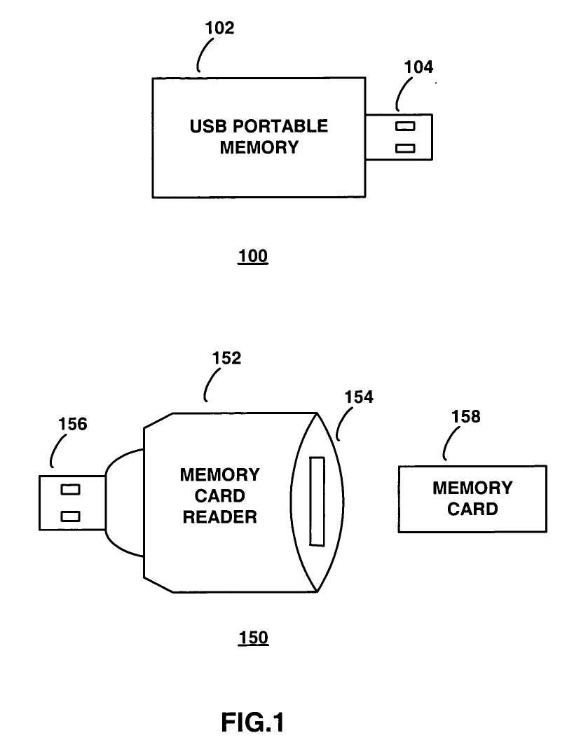

Referring now to FIGS. 1, 100 and 158 are few exemplary portable memory devices that may be used to practice the current invention. This invention refers such and similar devices as “portable memory devices” or “portable memory”. It should be noted that these are for illustration purposes only and not to be construed as a limitation. While this term is intended to refer to what is now commonly known as the portable memory drives, it is also intended to encompass variations that may be made in the future, including changes and additions that may be made to these devices without departing from the scope of present invention. This invention may be practiced using any types of portable memory devices that exists today or any alterations that may happen to them in future. Generally, when this invention refers to the term “portable memory”, it implies a unitary portable memory device that can store files from a computing device and the computing device can read files from the memory device by temporarily attaching the device to the computing device. Further, these devices are easily carried along by a user. Moreover, the device may be embedded within commonly used portable items, provided, the memory device is unitary and does not depend upon the portable item that may house the memory device to operate functionally. For example, these devices may be embedded within a key chain, wristwatch, pen and the like.

In FIG. 1, universal serial bus (hereinafter USB) removable memory 100 comprises a memory unit 102 with USB port connector 104. These devices sometimes referred to as “key chain” memory devices or plug-and-play memory devices. These devices are becoming increasingly popular due to affordability, portability and amount of data they may carry and have become a class of indispensable peripherals that are widely utilized by computer users. In fact, these devices can be easily carried in a key chain or in a wallet. These devices are generally not permanently fitted to a computing platform, such as a personal computer. Rather they can be conveniently attached to and removed from any computing device having the appropriate connection port (e.g. a serial bus port like a USB port, or IEEE 1394 or “Firewire” port). Memory cards are another popular portable memory devices. These cards do not have a port connector like a USB removable memory. As shown in 150, memory card 158 can exchange data files from a computing device, like a personal computer, using a memory card reader 152. A memory card reader 152 has a slot 154 to conveniently attach and remove a memory card 158, and a port connector, like, a USB port connector 156 on another end. When attached, an operating system of the computer (e.g. Microsoft Windows XP) supporting plug-and-play architecture can detect the portable memory device automatically and can treat the memory device, as if, it resides on the computer system. User can easily transfer files to and from the memory device, and when done, can eject or detach the memory device and easily carry along.

This invention will be practiced in computing environments, wherein the portable memory device of a customer is temporarily connected to a computer system of a business entity or incentive program provider entity. Those skilled in the art will appreciate that the invention may be practiced in environments with many types of computer system configurations, including personal computers, point of sale (POS) computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices or computer readable mediums.

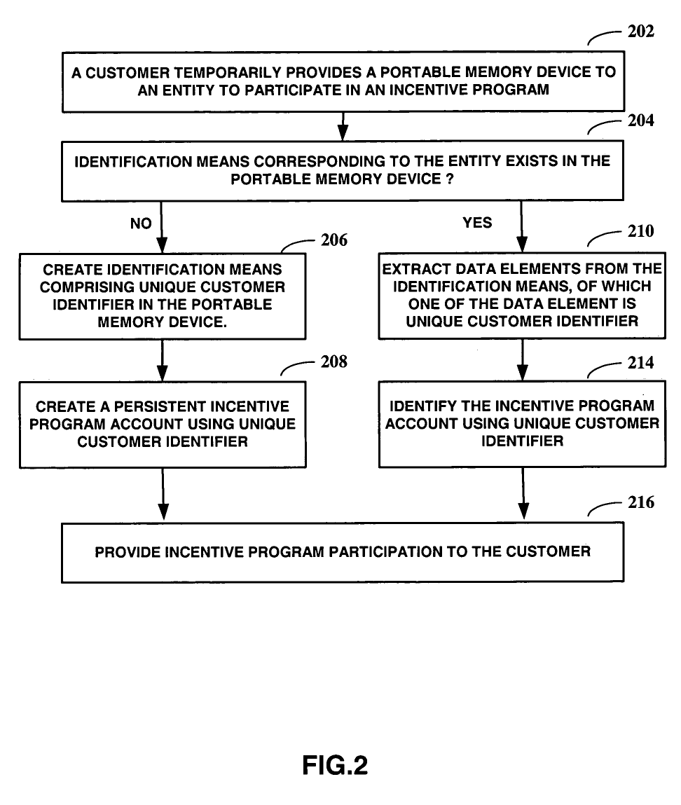

FIG. 2 depicts a flow chart of the method of present invention for using a portable memory device to participate in an incentive program provided by an entity. In accordance with this method, a customer temporarily provides a portable memory device to the entity at step 202. Providing “temporarily” means the customer providing the portable memory device to the entity only for the duration of participation in the incentive program and receiving the device back once the participation is over. The customer may provide the portable memory during a business transaction at a Point Of Sale (POS, hereinafter “point of sale”) or at a customer service center of the entity. The portable memory device will be connected to a computer system used by the entity.

When this invention uses the term “entity”, it implies any organization, business entity or government entity or a third party entity, acting on behalf of another entity. For example, a business entity may have outsourced its information technology related activities to another third party entity. The scope of the term entity applies equally to all those scenarios.

At step 204, the entity check whether identification means corresponding to the entity exists in the portable memory device. The identification means comprises of a unique customer identifier that uniquely identifies the customer with the entity and may comprise many other data elements that are explained in later sections. In one example, the identification means is a file with unique file name created by the entity on the portable memory. The identification means further comprises an association means that links or ties the unique customer identifier and other data elements with the entity. In one example, the association means is the unique file name used to represent the file created by the entity, wherein the file itself comprise the unique customer identifier and other data elements. For example, the entity may create a file with unique file name—“storemart1.inc”—on the portable memory device with unique customer identifier “XYZ1002”. During subsequent visits by the customer, the entity looks for file name “storemart1.inc” in the portable memory device and reads associated unique customer identifier and other data elements.

Alternatively, the entity may write identification means to a common file on the portable memory device. In this case, the identification means is a combination of one or more data elements with the unique entity identifier. For example, the portable memory device may have a common file named—“incentiveids”—that is used with a plurality of entities. Each entity writes an entry into this file, for example, an entry “userid=XYZ1002 entity=storemart1”. After receiving the portable memory from the customer, the entity may look for the pattern “entity=storemart1” and extracts customer identifier associated with that combination.

If the identification means does not exist on the portable memory device, process of the method branches to step 206. During this step, the entity generates a unique user identifier and creates the identification means in the portable memory device. In one embodiment, this step is used to create an instant incentive program account for the customer, without requesting any personal information from the customer, for example, name, address, phone number, email address and the like. The entity generates an anonymous and unique customer identifier and creates the identification means in the device. This allows for instant incentive account creation with minimal amount of time and may happen during a point of sale business transaction conducted by the customer with the entity. Since the customer is identified anonymously and the customer need not provide any personal information or need to spend time filling the incentive program forms, the customer may be more willing to accept and participate in such programs. For example, a gas station may accept a portable memory device from a customer at an automated point of sale near gas pump by providing a portable memory connector and creates an instant incentive program account on the portable memory without requesting any personal information from the customer. The gas station may provide incentives for identifying with the gas station using this anonymous identifier during subsequent visit by the customer, thus, creating loyalty relationship with the customer.

In next step 208, the entity creates a persistent incentive program account. The incentive program account and related information is made persistent by storing in a non-volatile computer readable medium, for example, in a database on the hard disk of a computer system used by the entity. Once the account is created, it is linked or associated with the unique customer identifier such that the entity can relate to the account during subsequent visits by the customer, just by accepting the portable memory device at a point of sale. In many cases, the incentive program account identification is the unique customer identifier. However, the entity may link the unique customer identifier to a different internal account number by maintaining a lookup table or by other means.

If the identification means already exists at step 204, the process of this method branches to the step 210. At step 210, the entity identifies the identification means in the portable memory device by using the association means of the identification means, for example, a unique file name. Once the identification means is located, the entity extracts the data elements of the identification means, of which, one of the data element is the unique customer identifier. Since the unique customer identifier is linked to the incentive program, at step 214, the entity identifies the incentive program account associated with the unique customer identifier.

At step 216, the entity provides the participation in the incentive program to the customer. Various benefits may be tied to the incentive program. In one example, the customer may receive member benefits, for example, membership benefits at a grocery store, with an airline, with mass merchandise stores like Sam's club and Costco. The participation may also involve awards based on an awardable activity performed by the customer. For example, a fast food restaurant may use this method to replace the current “stamp” program. The awardable activity in this case may refer to buying a meal from the restaurant at full price. Each time the customer makes a purchase, the customer may provide the portable memory device to anonymously identify with the restaurant. The restaurant adds bonus points against the incentive program account. After accumulating certain bonus points, the customer may redeem it for a free meal.

In another embodiment of this method, the entity may request the customer to provide personal information during the step 206. This may be minimal information, for example, an email address of the customer, postal code of the location where the customer lives or more detailed information like, name, address, driver license number and the like. Some entities may even photograph the user and may get digital image of the signature of the customer to reduce fraudulent participation in the incentive program. Some paid membership programs may use this approach. Once the entity collects all these information, the entity may use them to create identification means on the portable memory device. In such cases, the identification means may be a file directory or file archive with a plurality of files, for example, one file corresponding to digital image of the customer photograph and another file corresponding to digital image of the customer signature. Various other data elements may be placed in the identification means. For example, the entity may provide several incentive programs and may include the incentive program identifier as one of the data element in the identification means. If the identification means is represented by a directory, the association means may be a unique directory name that corresponds to the entity. Further, the entity may digitally sign these files to avoid any fraudulent modification by the customer and to protect the sensitive information of the customer in case of loss of the portable memory device.

Some of the steps described in the method of present invention are implemented using computer programs. In short, a computer program referred in this invention comprised of a multitude of instructions executable by a computer. The computer program may be developed in a computer language with a multitude of instructions that will be translated by the native computer into a machine-readable format and hence executable instructions that can reside in a memory or computer readable mediums and executed by the computer processor or CPU (central processing unit) to generate results as described in the teachings of the present invention. Also, computer programs are composed of variables and data structures that either reside locally to a program or are found in memory or storage devices. In general, a computer program may consist of components, modules, objects, routines or sequence of instructions, blocks of code sections, each performing a specific unit of work at different time intervals during the execution of the computer program. Also, computer program may be written in various languages to produce more or less similar results. Furthermore, the computer program may be part of an operating system, or other application programs. Any specific nomenclature used in this description is for illustrative purposes only and not to be construed as a limitation.

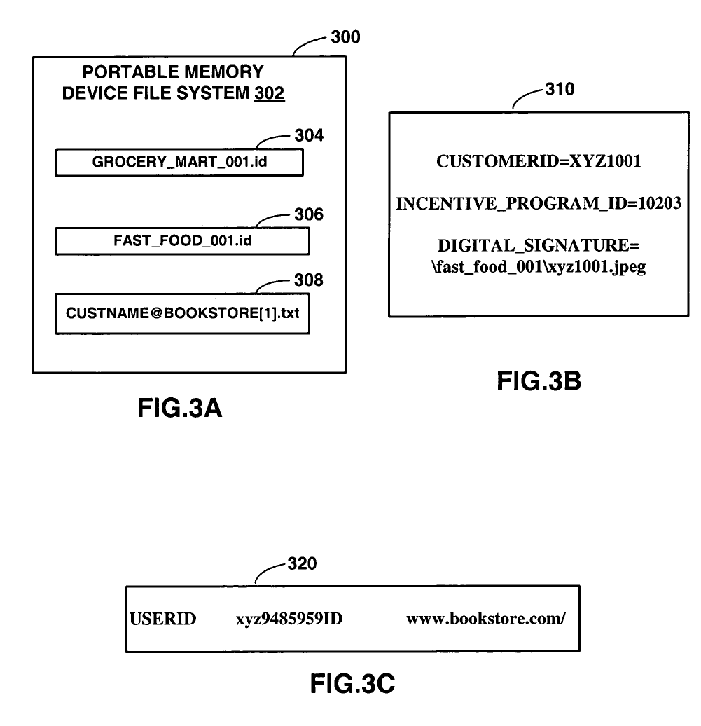

FIG. 3A depicts exemplary contents of a portable memory device representing the identification means for a plurality of incentive programs. Portable memory 300 comprises file system 302 with files 304, 306 and 308 representing identification means for corresponding incentive programs with different business entities. The identification means 304 in the form of a file is created by a grocery store to anonymously identify a customer and to provide participation in an incentive program. The incentive program account is created without requesting any information from the customer.

The identification means 306 is created by a fast food restaurant to provide anonymous participation of the customer in its incentive program. During creation of the identification means 306, the fast food retardant requests a sample signature of the customer. This may be done by requesting the customer to sign on a digital signature pad. The digital image of the signature is also stored on the portable memory device and files are digitally signed by the fast food restaurant. During award redeem by the customer, the restaurant may request the customer to sign again and compares the signature with the signature stored in the identification means 306. If the signatures match, the restaurant grants the award to the customer.

Both of the identification means 304 and 306 are created by respective entities in the portable memory device at a point of sale. The identification means file 308 represent a cookie file placed by an associated web site of an incentive program provider entity. In short, a cookie file is a file created on a computer of the user by a web site on a computer network, for example, the Internet, to anonymously identify and store some user specific information. This business entity allows the user to copy the cookie file placed by its web site or an associated web site into the portable memory device to use as the identification means to participate in the incentive program with a physical location of the business entity.

FIG. 3B represents exemplary contents 310 of the identification means 306 of FIG. 3A. The identification means file “FAST_FOOD_{—}001.id” comprises data elements, which are, a customer id “XYZ1001” to uniquely identify the customer, incentive program identification “10203” to specify the incentive program type, and location of signature of the customer in digitized form, which is represented by “\fast_food_{—}001\xyz1001.jpeg”. An incentive program provider entity can create any number of name-value pairs or data elements in the identification means. In this illustration, association means of the identification means is the file name itself, which is “FAST_FOOD_{—}001.id”. During subsequent visits by the customer, the entity looks for this file name, and if found and valid, provides participation in the incentive program.

In another aspect of the present invention, a bookstore allows using a cookie file placed by the web site of the bookstore as identification means. The identification means 308 of FIG. 3A, which is also a cookie file CUSTNAME@BOOKSTORE[1].txt placed by the web site on a computer of the customer, and customer copied the file to the portable memory device to anonymously participate in point of sale incentive program with the bookstore. The bookstore may encourage using common anonymous identification to anonymously identify the customer at a point of sale in the bookstore as well as with the web site. Generally, the cookie files are located at a particular location on customer's computer. For example, in Microsoft Windows environment, these files are located at a directory location c:\windows\cookies.

Referring now to FIG. 3C, exemplary contents 320 represent the identification means 308, which is also the cookie file. Alternatively, the identification means created by a business entity on the portable memory device may be used as a cookie file to anonymously identify with an associated web site. Further, the bookstore may provide discounts during online purchases made by the customer at the web site of the bookstore based on incentives earned at a point of sale of a physical location of the bookstore.

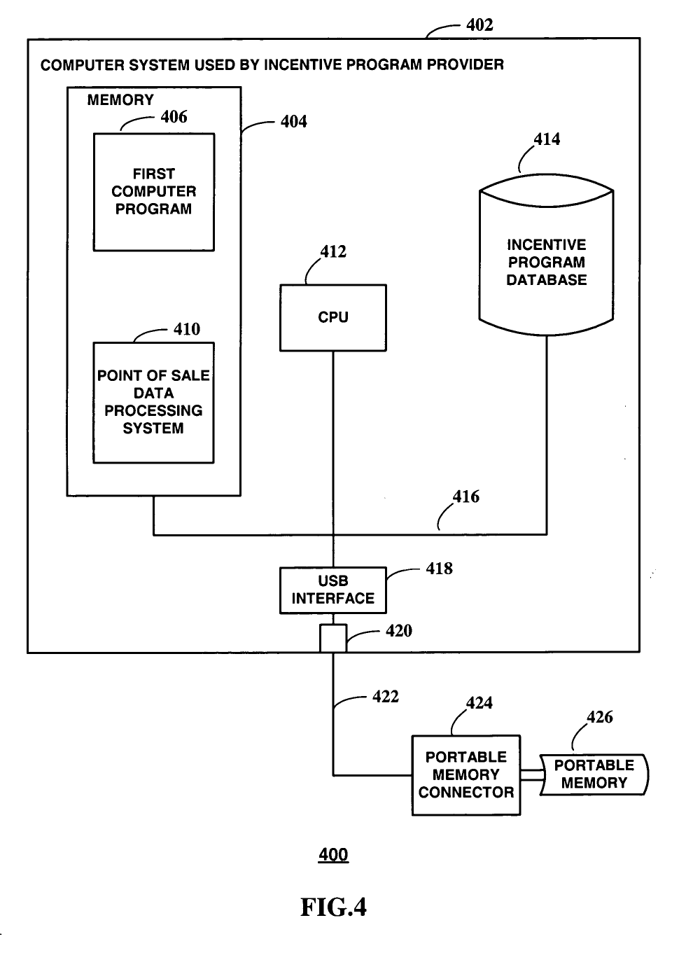

Referring now to FIG. 4, an exemplary system 400 for implementing the method of the present invention. The system 400 comprises a computer system or computer 402. The computer 402 comprises a processor or central processing unit (CPU) 412, a memory or computer readable medium 404, an incentive program database 414, which is stored on a hard disk, which is another form of computer readable medium of the computer 402. The incentive program database 414 is used to persist various information including the incentive program account identification and earned bonus points related to the incentive program. The computer further comprises a means to receive a portable memory device, which, in this illustration, is a combination of universal serial bus (USB) interface 418 and a USB data port connector 420.

The system 400 further comprises a portable memory device 426 temporarily provided by the customer to participate in the incentive program. The business entity may provide a data cable 422 and a portable memory connector 424 to allow the customer to attach the portable memory device conveniently at a point of sale.

In general, the routines executed to implement the embodiments of the invention, whether implemented as a stand-alone computer application or as part of an operating system or a specific application or as part of a software product are in the first computer program 406, or the computer program 406. The first computer program 406 resides in a computer readable medium, which is a random access memory 404 of a computer 402. The computer 402 is also used by the vendor to process point of sale business transactions using a point of sale data processing system 410, also residing on the memory 404. The instructions of the computer program 406 can be resident at various times in various memory and storage devices in the computer system 402. When read and executed by one or more processors 412 in the computer 402, the program 406 causes the computer system 402 to perform the steps necessary to execute steps or elements embodying the various aspects of the invention. For example, the computer program 406 checks whether the identification means exists on the portable memory device 426. Various components of the computer 402 are interconnected to the CPU 412 by the system bus 416. The first computer program 406 may interact with a point of sale data processing system 410 to identify whether the customer conducted any business transaction that earns compensation as a part of the incentive program. Further, the first computer program may have instructions representing the rules of the incentive program and comprises various incentive program database interaction routines.

The computer program 406 may also have instructions to check whether any harmful computer files, for example, “computer viruses” exists on the portable memory device before continuing with incentive program related processing. If any such harmful files exist on the device, the entity may abort the processing and refuse to provide such service to the customer.

The invention is described using various examples and preferred embodiments herein. However, it should be noted that examples are provided only for illustration and one skilled in the art can readily devise many other varied embodiments that still incorporate these teachings without departing from the scope of the invention. The invention is therefore claimed in any of its forms or modifications within the proper scope of the appended claims.

1. A method for using a portable memory device by a customer to participate in an incentive program provided by an entity to the customer, the method comprising:
said customer temporarily providing said portable memory device to said entity;
checking whether an identification means corresponding to said entity exists in said portable memory device, wherein a unique customer identifier of said identification means uniquely identifies said customer to said entity;
if said identification means does not exist, said entity creating said identification means in said portable memory device and creating an account for said customer, corresponding to the incentive program, wherein said account is linked with said unique customer identifier; and
providing participation in said incentive program to said customer.

2. The method of claim 1, wherein said entity creating said account, without requesting any information related to said customer.

3. The method of claim 1, wherein said unique customer identifier is used to anonymously identify said customer.

4. The method of claim 1, wherein said identification means comprising at least one file in said portable memory device.

5. The method of claim 4, wherein said file is used by said customer to anonymously identify with a web site associated with said entity by copying said file to a cookie folder on a computer used by said customer.

6. The method of claim 5, wherein said anonymously identifying with said web site is used by said customer to receive online incentive provided by said web site.

7. The method of claim 6, wherein said online incentive is a discount provided by said web site towards online purchase conducted by said customer with said web site.

8. The method of claim 4, wherein said file having a unique file name corresponding to said entity.

9. The method of claim 4, wherein said file is digitally signed by said entity.

10. The method of claim 1, wherein said participation in said incentive program comprising of said customer receiving membership benefits associated with said incentive program.

11. The method of claim 1, wherein said participation in said incentive program further comprising of providing an instant discount towards a purchase by said customer.

12. The method of claim 1, wherein said participation in said incentive program further comprising:
checking for any awardable activity performed by said customer with said entity; and
compensating said customer, wherein said compensation comprises of addition of value to said account.

13. The method of claim 12, wherein said awardable activity is said customer purchasing at least one of a product and a service from said entity.

14. The method of claim 12, wherein the accumulated value in said account is redeemed for an award.

15. The method of claim 12, wherein said value is in the form of bonus points.

16. The method of claim 12, wherein said value is of monetary nomination.

17. The method of claim 1, wherein said identification means further comprising:
said unique customer identifier; and
an association means to associate said unique customer identifier with said entity, wherein said entity receives said unique customer identifier from said portable memory device by using the association means.

18. The method of claim 17, wherein said identification means further comprising at least one of a: identifier for said incentive program, name of said customer, address of said customer, telephone number of said customer, photo image of said customer, photo image of the signature of said customer, and a personal identification of said customer.

19. The method of claim 17, wherein said association means is the unique file name of the file written by said entity on said portable memory device, wherein one of the data component within said file comprising said unique user identifier and, said entity retrieves said unique customer identifier by reading said file.

20. The method of claim 17, wherein said association means is a combination of a unique entity identifier and said unique customer identifier and writing this combination to a file on said portable memory device, wherein said entity retrieves said unique customer identifier from said portable memory device by searching for unique entity identifier in said file.

21. The method of claim 1, wherein said portable memory device is a portable flash memory product.

22. The method of claim 1, wherein said portable memory device is a portable memory card.

23. The method of claim 1, wherein said entity is one of a business entity and a government entity.

24. A system for providing an incentive program by an entity to a customer using a portable memory device, the system comprising:
a computer comprising a processor and means to receive portable memory device;
a removable portable memory device connected to said computer; and
said computer further comprising at least one computer readable medium comprising:
the incentive program data base;
a first computer program comprising a set of instructions when executed by said processor causes the computer to perform the steps of:
checking whether the incentive program identification means exists in said portable memory device, wherein a unique customer identifier of said incentive program identification means uniquely identifies said customer to said entity;
if said incentive program identification means does not exist, creating said incentive program identification means in said portable memory device and creating an incentive program account and linking said incentive program account with said unique customer identifier and storing in said incentive program data base;
if said incentive program identification means exists, reading said incentive program identification means and extracting data elements, wherein one of the data element is said unique customer identifier; and
providing participation in said incentive program to said customer.

25. The system of claim 24, wherein said first program further comprising instructions, when executed by the processor causes the computer to check the portable memory device for any harmful files and to abort the processing if harmful files exist in the portable memory device.
